(19) United States
(12) Patent Application Publication
(10) Pub. No.: US 2008/0083297 A1
(43) Pub. Date: Apr. 10, 2008

(54) STEERING WHEEL

(76) Inventors: Yuejun Yan, Shenzhen (CN); Yuepeng Yan, Shenzhen (CN)

Correspondence Address: MATTHIAS SCHOLL, 14781 MEMORIAL DRIVE, SUITE 1319, HOUSTON, TX, 77079, US

(21) Appl. No.: 11/680,633

(22) Filed: Mar. 1, 2007

(30) Foreign Application Priority Data
Oct. 7, 2006 (CN) 200610063010.5

(51) Int. Cl. B62D 1/04

(52) U.S. Cl. 74/552

(57) ABSTRACT

The present invention teaches a steering wheel for a vehicle comprising a grip frame; one or more spoke frames; a supporting shaft; and at least one force-cushioning element; wherein the spokes connect the grip frame to the supporting shaft; the grip frame and/or the spoke frames comprise two or more parts; the force-cushioning element is disposed between the parts; and the force-cushioning element is capable of being deformed by a force exerted by a driver colliding with the steering wheel whereby deforming the grip frame and/or the spoke frames.

### CROSS-REFERENCE TO RELATED APPLICATIONS

This application claims priority to Chinese Patent Application No. 20061006310.5 filed on Oct., 07, 2006. The contents of which are incorporated herein by reference.

### BACKGROUND OF THE INVENTION

1. Field of the Invention

This invention relates to a steering control apparatus for a vehicle, and more particularly, to a steering wheel having force-cushioning elements.

2. Description of the Related Art

In vehicle collisions, a major threat to the driver's life and safety comes from impacting the steering wheel. This is because conventional steering wheels are made of rigid materials, which while allowing for an easy rotation of the steering wheel about a supporting shaft, often impact with the driver's body at a great force when the driver collides with the steering wheel in a direction normal or substantially normal to the plane of the wheel. In such collisions, the wheel generally damages the driver's internal organs, which often carries fatal consequences.

### SUMMARY OF THE INVENTION

In view of the above-described problems, it is one objective of the present invention to provide a steering wheel having force-cushioning elements so as to cushion a force impacting from a direction normal or substantially-normal to the plane of the steering wheel.

To achieve the above objective, in accordance with one embodiment of the present invention, provided is a steering wheel for a vehicle comprising a grip frame; one or more spoke frames; a supporting shaft; and at least one force-cushioning element; wherein the spokes connect the grip frame to the supporting shaft; the grip frame and/or the spoke frames comprise two or more frame parts; the force-cushioning element is disposed between the frame parts; and the force-cushioning element is capable of being deformed by a force exerted by a driver colliding with the steering wheel whereby deforming the grip frame and/or the spoke frames.

In certain classes of this embodiment, the cushioning element is capable of absorbing kinetic energy while being deformed by the force, the force being normal to a plane defined by the grip frame.

In certain classes of this embodiment, the grip frame comprises an upper grip frame portion and a lower grip frame portion, wherein at least one force-cushioning elements is disposed between the upper grip frame portion and the lower grip frame portion.

In certain classes of this embodiment, the spoke frame comprises an upper spoke frame portion and a lower spoke frame portion, wherein at least one force-cushioning elements is disposed between the upper spoke frame portion and the lower spoke frame portion.

In certain classes of this embodiment, the force-cushioning element is disposed between the spoke frame and the supporting shaft.

In certain classes of this embodiment, the force-cushioning element is selected from a group consisting of a flat plate, an L-shaped plate, and a plate having a tooth-shaped surface.

In accordance with another embodiments of the invention provided is a steering wheel for a vehicle comprising a grip frame; one or more spoke frames; a supporting shaft; and at least one force-cushioning element; wherein the spoke frames connect the grip frame to the supporting shaft; the grip frame is annularly-shaped and elastic, the spoke frames are elastic; and the grip frame and the spoke frames are rigid in a direction parallel to a plane defined by the grip frame, yet are also capable of being elastically-deformed by a force exerted by a driver colliding with the steering wheel whereby deforming the grip frame and/or the spoke frames.

In certain classes of this embodiment, the cushioning element is capable of absorbing kinetic energy while being deformed by the force, the force being normal to a plane defined by the grip frame.

In certain classes of this embodiment, the grip frame is an annularly-shaped flat plate and the spoke frame is an elastic plate.

The steering wheel of the present invention provides the following general advantages: (1) in the working direction such as the rotating direction of the steering wheel, the steering wheel is rigid so that the steering control to the vehicle is not influenced; and (2) in the event of a collision, e.g., a frontal collision, the steering wheel is impacted by the body of a driver, and correspondingly, is deformed forward by means of the force-cushioning element, thereby reducing or avoiding an injury to the driver.

### BRIEF DESCRIPTION OF THE DRAWINGS

FIG. 1 is a top plan structural view of a steering wheel in accordance with one embodiment of the invention;

FIG. 2a is a perspective view of a force-cushioning element in accordance with one embodiment of the invention;

FIG. 2b is a side view of a force-cushioning element of a steering wheel in accordance with one embodiment of the invention;

FIG. 3 is a side structural view of a deformed forward steering wheel in accordance with one embodiment of the invention;

FIG. 4 is a top plan structural view of a steering wheel in accordance with another embodiment of the invention;

FIGS. 5a-b are each a side structural view of a steering wheel in accordance with another embodiment of the invention;

FIGS. 6a-b are each a side structural view of a steering wheel in accordance with yet another embodiment of the invention; and

FIG. 7 is a top plan structural view of a steering wheel in accordance with yet another embodiment of the invention.

### DETAILED DESCRIPTION OF THE INVENTION

The configuration of a steering wheel according to the embodiments of the present invention is explained hereinafter with reference to the drawings.

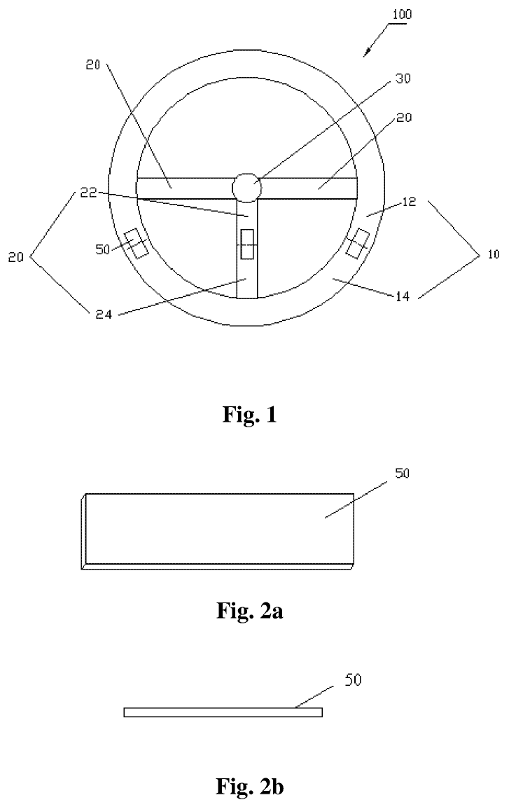

FIG. 1 is a top plane structural view of a steering wheel 100 in accordance with one embodiment of the present invention. The steering wheel 100 comprises: a grip frame 10; one or more spoke frames 20; a supporting shaft 30; and at least one force-cushioning element 50, wherein the grip frame 10 is connected and integrated by means of the spoke frames 20 and the supporting shaft 30; the grip frame 10 consists of an upper portion 12 and a lower portion 14; the force-cushioning element 50 is disposed between the upper portion 12 and the lower portion 14; the spoke frame 20 for connecting the lower portion 14 of the grip frame 10 and the supporting shaft 30 consists of an upper portion 22 and a lower portion 24, wherein the force-cushioning element 50 is installed between the upper portion 22 and the lower portion 24. The two ends of the force-cushioning element 50 are fixed respectively at the connection position between the upper portion 12 and the lower portion 14 by means of bolting or mechanical pressing. Similarly, the two ends of the force-cushioning element 50 are fixed respectively at the connection position between the upper portion 22 and the lower portion 24. The force-cushioning element 50 is made of an elastic steel plate or elastic memory material.

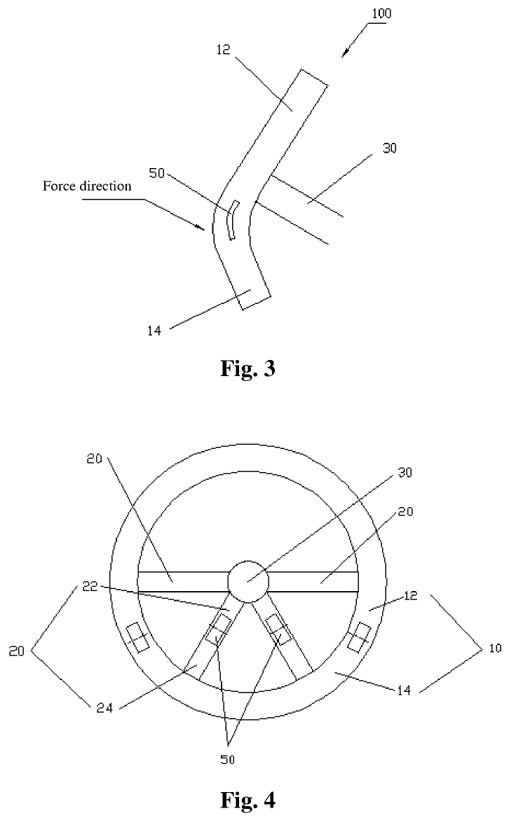

FIGS. 2a-2b illustrate a perspective view and a side view of the force-cushioning element 50, respectively, in accordance with one embodiment of the present invention. In the present embodiment, the force-cushioning element 50 is an elastic plate, and is installed inside the grip frame and the spoke frames wherein the grip frame and the spoke frames are of a circular pipe design. In other embodiments, the force-cushioning element 50 is disposed outside, topside or underside of the grip frame and/or the spoke frames. In certain embodiments, the grip frame and the spoke frames are made of, e.g., circular metal pipe (hollow or filled), having one or multiple layers.

In this embodiment, the force-cushioning element is an elastic plate which is coplanar with the steering wheel. The elastic plate is rigid in the direction of rotation allowing the steering wheel to be rotated, yet elastic in the direction normal or substantially-normal to the plane of the gripping frame (i.e., the plane of the drawing in FIG. 1) allowing the steering wheel to be elastically deformed when the steering wheel is being impacted by the driver's body during collision so as to absorb the force of impact of the driver's body.

FIG. 3 is a side view showing a deformed steering wheel in accordance with one embodiment of the present invention. When the front portion of the steering wheel 100 is being impacted, at least one force-cushioning element 50 of the grip frame 10 and the spoke frames 20 will be elastically deformed so as to cushion the force and thereby to protect the driver. When the steering wheel 100 is under normal operation, the force-cushioning element 50 is rigid so that the steering performance of the steering wheel 100 is not influenced.

As shown in FIG. 4, in another embodiment of the present invention, the grip frame 10 consists of an upper portion 12 and a lower portion 14, wherein the lower portion 14 of the grip frame 10 and the supporting shaft 30 are connected by means of one or more spoke frames 20; at least one spoke frame 20 consists of an upper portion 22 and a lower portion 24, wherein a force-cushioning element 50 is installed at the juncture between the upper portion 22 and the lower portion 24.

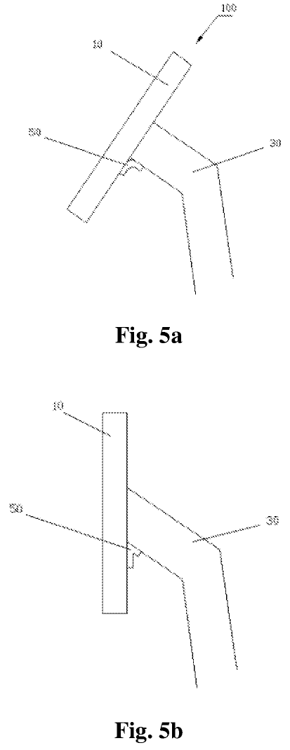

FIG. 5a-b illustrate a side structural view of a steering wheel in accordance with other embodiment of the present invention. As shown in FIG. 5a, the steering wheel 100 includes a grip frame 10; one or more spoke frames (not shown); a supporting shaft 30; and a force-cushioning element 50. The grip frame 10 is connected and integrated by means of the spoke frame and the supporting shaft 30. As differentiated from conventional steering wheels, the grip frame 10 and spoke frame of the steering wheel 100 are movably-affixed to the supporting shaft 30 and have a certain play relative to the supporting shaft 30. The force-cushioning element 50 is disposed at a position between the spoke frame and the supporting shaft 30. In the present embodiment, the force-cushioning element 50 is a corner shaped elastic plate.

As shown in FIG. 5b, the elastic corner plate is rigid in the direction of rotation (in any direction within the plane of the gripping frame) allowing the steering wheel to be rotated, yet elastic in a direction normal or substantially-normal to the plane of the gripping frame allowing the steering wheel to be elastically deformed when the steering wheel is being impacted by the driver's body during collision so as to absorb the force of the impact with the driver's body.

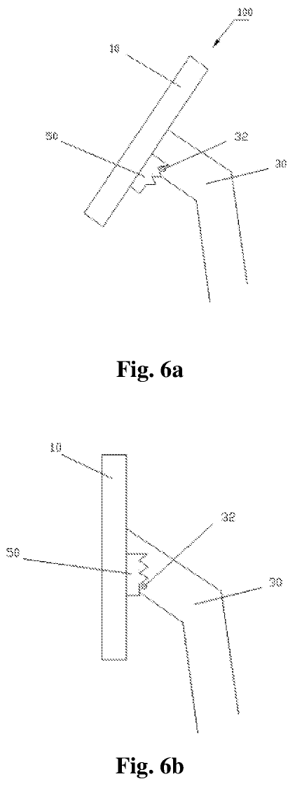

FIGS. 6a-b illustrate a side structural view of a steering wheel in accordance with another embodiment of the present invention. As shown in FIG. 6a, the steering wheel 100 includes a grip frame 10; a spoke frame (not shown); a supporting shaft 30; and a force-cushioning element 50. As differentiated from conventional steering wheels, the grip frame 10 and spoke frame of the steering wheel 100 are movably-affixed to the supporting shaft 30, and have a certain play relative to the supporting shaft 30. The force-cushioning element 50 is disposed at a position between the spoke frame and the supporting shaft 30. In the present embodiment, the force-cushioning element 50 is a rack 50 with a plurality of teeth. A positioning device 32 is installed on the supporting shaft 30 to interact with the rack 50. Under normal operating conditions, the rack 50 is aligned with the positioning device 32 at a first position of the rack 50, as shown in FIG. 6a.

When the steering wheel 100 is being rotated, i.e., under a normal rotating force, the rack 50 is rigid with respect to the steering wheel 100, and is geared with the positioning column 32. However, when the steering wheel 100 is being impacted by the driver's body in a collision, the plane of the steering wheel 100 changes orientation (from that shown in FIG. 6a to that shown in FIG. 6b). Thus, the rack 50 will be moved and re-aligned with the positioning device 32 at a second position of the rack 50 as shown in FIG. 6b, and in doing so will cushion the impacting force. The impacting forced is cushioned during the process of deformation.

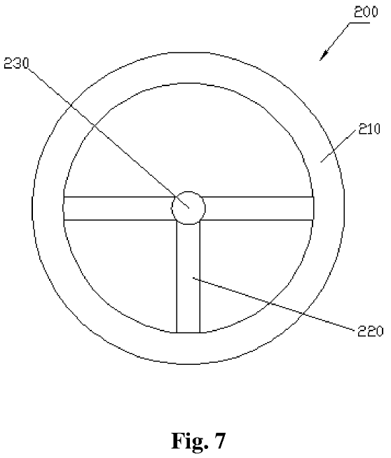

FIG. 7 is a structural view of a steering wheel in accordance with another embodiment of the present invention. In the present embodiment, a steering wheel 200 includes a grip frame 210, one or more spoke frames 220, and a supporting shaft 230, wherein the grip frame 210 is an annular-shaped elastic plate or column. The entire spoke frame 220 is an elastic plate. The grip frame 210 and the spoke frames 220 are rigid in the direction of rotation (in any direction parallel to the plane of the gripping frame) allowing the steering wheel 200 to be rotated, yet can be elastically force-deformed in a direction normal or substantially-normal to the plane of the gripping frame allowing the steering wheel 200 to be elastically deformed when the steering wheel is impacted by the driver's body during a collision so as to absorb the force of the impact with the driver's body.

The outer surfaces of the grip frame 210 and the spoke frames 220 are covered by sponge or leather material so as to improve the comfort of gripping.

In accordance with other embodiments of the present invention, the force-cushioning element of the steering wheel also can be installed at the top portion of the supporting shaft so as to cushion the impacting force, e.g., of the driver's head, to the steering wheel.

In accordance with the present invention, the steering wheel comprises at least one force-cushioning element, or at least one part of the steering wheel is made from an elastic material. The steering wheel is rigid with respect to a normal force applied to the wheel to turn it and to steer the vehicle, so that the steering performance of the vehicle is not influenced. However, in the event of a frontal collision, the steering wheel will be impacted by the body of the driver, and correspondingly, it will be deformed as a result of it incorporating one or more force-cushioning elements. Thus, an injury to the driver can be avoided or greatly reduced.

The force-cushioning element is made of materials capable of being deformed in one direction but not in another direction. This is accomplished by providing specially-engineered materials and/or by providing conventional materials shaped so as to achieve the desired properties.

Energy absorption in a force-cushioning element occurs without limitation via a plastic deformation, an elastic deformation, or by the fluid dynamics of gases or liquids within the material.

The force-cushioning materials are selected without limitation from the group consisting of, e.g., soft steel, various metal alloys, polymers, such as, expanded polystyrene, polyurethanes, polyethers, or polyethylene, silica aerogels, and natural or synthetic fibers having uniform or random orientations.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A steering wheel for a vehicle comprising
a grip frame;
one or more spoke frames;
a supporting shaft; and
at least one force-cushioning element;
wherein
said spoke frames connect said grip frame to said supporting shaft;
said grip frame and/or said spoke frames comprise two or more frame parts;
said force-cushioning element is disposed between said frame parts; and
said force-cushioning element is capable of being deformed by a force exerted by a driver colliding with the steering wheel whereby deforming said grip frame and/or said spoke frames.

2. The steering wheel of claim 1, wherein said cushioning element is capable of absorbing kinetic energy while being deformed by said force, said force being normal to a plane defined by said grip frame.

3. The steering wheel of claim 1, wherein said grip frame comprises an upper grip frame portion and a lower grip frame portion, wherein at least one force-cushioning elements is disposed between said upper grip frame portion and said lower grip frame portion.

4. The steering wheel of claim 1, wherein said spoke frame comprises an upper spoke frame portion and a lower spoke frame portion, wherein at least one force-cushioning elements is disposed between said upper spoke frame portion and said lower spoke frame portion.

5. The steering wheel of claim 1, wherein said force-cushioning element is disposed between said spoke frame and said supporting shaft.

6. The steering wheel of claim 1, wherein said force-cushioning element is selected from a group consisting of a flat plate, an L-shaped plate, and a plate having a tooth-shaped surface.

7. A steering wheel for a vehicle comprising
a grip frame;
one or more spoke frames;
a supporting shaft; and
at least one force-cushioning element;
wherein
said spoke frames connect said grip frame to said supporting shaft;
said grip frame is annularly-shaped and elastic,
said spoke frames are elastic;
said grip frame and said spoke frames are rigid in a direction parallel to a plane defined by said grip frame yet are capable of being elastically-deformed by a force exerted by a driver colliding with the steering wheel whereby deforming said grip frame and/or said spoke frames.

8. The steering wheel of claim 7, wherein said grip frame is an annularly-shaped flat plate and said spoke frame is an elastic plate.
